(19) United States
(12) Patent Application Publication
(10) Pub. No.: US 2013/0170922 A1
(43) Pub. Date: Jul. 4, 2013

(54) METHOD AND A PLANT FOR WASHER PRODUCTION AND A WASHER

(71) Applicant: Kurt Persson, Mattmar (SE)

(72) Inventor: Kurt Persson, Mattmar (SE)

(73) Assignee: NORD-LOCK AB, Mattmar (SE)

(21) Appl. No.: 13/642,217

(22) PCT Filed: Apr. 15, 2011
(86) PCT No.: PCT/SE2011/050463

§ 371 Date: Mar. 15, 2013

(30) Foreign Application Priority Data
Apr. 20, 2010 (SE) 1050390-2

(51) Int. Cl. F16B 39/24; B21D 53/22

(52) U.S. Cl. CPC F16B 39/24; B21D 53/22
USPC 411/161; 470/42; 470/163

(57) ABSTRACT

A method for producing metallic washers (1) for locking in bolted joints, a washer having an annular configuration and on one side (9) a pattern of radially extending cams (10) and on the other side having a pattern of radially extending teeth (3), the washers on at least the side (2) having the pattern of teeth having a surface with a hardness preferably exceeding the hardness of the material to interact with the washer pattern of teeth in a locking operation. The method is especially characterized in the steps of—coating a batch of washers (1) with a corrosion resistant outer surface layer (7), the hardness of which exceeding the hardness of the material (6) to interact with the washer pattern of teeth (3) in a locking operation. The present invention also relates to a washer and a plant.

### BACKGROUND

1. Technical Field

The invention relates to a process for producing a washer for locking according to the introductory portion of the accompanying claim 1.

The present invention further relates to a plant according to the introductory portion of the accompanying claim 24.

The present invention also relates to a washer for locking according to the introductory portion of the accompanying claim 13.

2. Prior Art

Metallic washers of the kind described above are previously known. Washers of this kind are intended to be used in pairs, the sides being provided with a pattern of cams facing each other and the sides being provided with a pattern of teeth being turned outwardly and grip into a workpiece surface or a bolt head or a nut in a bolted joint. In order to obtain this, the teeth of the washers must be harder than the workpiece and the bolt head/nut, so that a penetration in the respective surface is enough to make sure that the friction in the contact between the teeth and the workpiece and bolt head/nut, respectively, exceeds the friction between the respective cam surfaces.

According to certain embodiments the metallic washers are made of steel, e.g. of stainless steel, eg acid-proof stainless steel. By cold forming of the washers the hardness increases by strain hardening. However, in this way the hardness increases to approximately the same level obtained by cold forming of bolts and nuts used in the relevant bolted joints. Therefore the washer hardness must be increased further to secure good function.

Another known method in addition to cold forming for obtaining a hard washer surface and suitable for batchwise production is hardening in the form of heat treatment in a carbon and hydrogen atmosphere, which method provides a hard enough surface. The method, however, suffers from high costs and results in very poor stainless properties of the surface.

An object of the present invention is to provide a method for batchwise provision of metallic washers with a hard washer surface and at the same time avoiding the drawbacks of the methods previously known and commented on above.

### SUMMARY OF THE INVENTION

This and other objects are obtained by a method, a plant and a washer having the features according to the appended claims 1, 24 and 13, respectively.

Further advantages, discussed later, are obtained by means of what is specified in the dependent claims.

According to the invention, washers are coated with a corrosion resistant outer surface layer having a hardness exceeding the hardness of the material to interact with the washer pattern of teeth in a locking operation.

By “coating” or “coated” is intended that the corrosion resistant outer surface layer is applied on the outer surface of the washer.

### BRIEF DESCRIPTION OF THE DRAWINGS

A better understanding of the present invention will be had when considering the following detailed description in conjunction with the accompanying drawings in which like details are designated with like numerals and in which

FIG. 1 schematically shows in cross-section one embodiment of a bolted joint using washers for locking, e.g. washers according to the present invention;

FIG. 2 shows one embodiment of a washer according to the present invention seen in a perspective view against the side having the pattern of teeth;

FIG. 3 shows a radial cross-section of a portion of a washer according to the present invention;

FIG. 4 shows a block diagram representing one embodiment of the process according to the present invention; and

FIG. 5 schematically shows one embodiment of a plant according to the present invention.

### DETAILED DESCRIPTION OF PREFERRED EMBODIMENTS

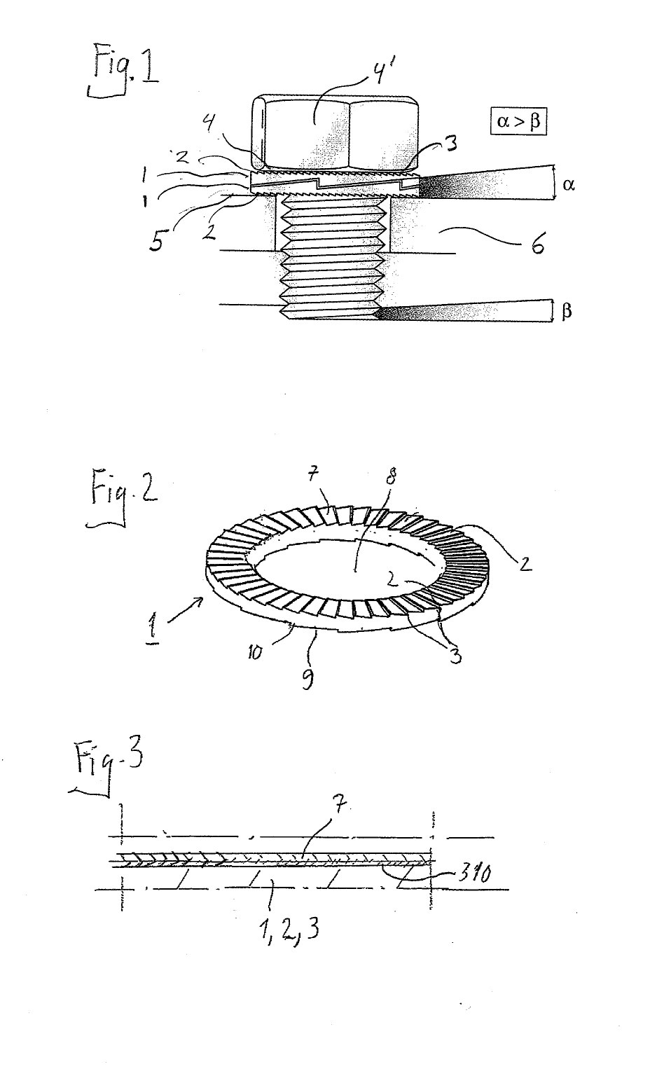

Metallic washers 1 of substantially the kind specified above are previously known and provided for e.g. bolted joints or the corresponding fastening elements for locking purposes. As schematically shown in FIG. 1 the sides 2 provided with a pattern of teeth 3 are turned outwardly in the pair of washers 1, the teeth being intended to grip into the bottom side 4 of the bolt head 4′ or the corresponding, e.g. a nut, and a surface 5 of e.g. a workpiece 6.

According to preferred embodiments of the invention the washers are made of steel, e.g. stainless steel. Sometimes especially preferred are washers of acid-proof stainless steel.

According to the present invention a washer is provided with an outer surface layer 7, FIG. 1, preferably intended to be harder than the material to interact with the washer pattern of teeth and, thus, into which the washer pattern of teeth is intended to grip.

According to one aspect of the present invention said surface layer 7 is made of a nickel alloy.

As shown in FIG. 3 a layer 310 of electrolytically applied pure nickel is, according to one embodiment, provided under said surface layer 7 of a nickel alloy to serve as a basic coating for said outer surface layer.

According to preferred embodiments said surface layer 7 comprises a nickel/phosphorus alloy. Preferred is that said nickel/phosphorus alloy comprises about 2-14% phosphorus by weight, and more specifically about 6-9% phosphorus by weight, the balance being nickel and normal impurities in the nickel phosphorus alloy.

Preferably, said surface layer 7 is applied by a so-called electroless nickel plating process, preferably by a so-called barrel plating process. Such processes are known per se, the surface layer being auto-catalytically reduced onto the washers. In a barrel plating process for washers, a batch of washers are immersed in a bath in a barrel for providing the desired surface layer.

According to preferred embodiments said surface layer 7 is about 10-50 μm thick.

Further, according to preferred embodiments, said surface layer 7 of the nickel/phosphorus alloy is heat treated at about 400° C. for about 1 hour or at about 200-300° C. for up to about 12 hours, preferably in an inert atmosphere and, according to one embodiment, preferably to a hardness of about 1000 HV.

According to one aspect of the present invention a method for producing washers is provided, the method thus being for batchwise production of steel washers for locking in bolted joints, a washer, FIG. 2, having a flat annular configuration with a central hole 8 and on one side 9 a pattern of radially extending cams 10 and on the other side 2 having a pattern of radially extending teeth 3, the method comprising the steps of providing a hard washer surface layer, the hardness of the layer being intended to exceed the hardness of the surface material, e.g. bolt-head, nut or workpiece to interact with the washer pattern of teeth 3 in a locking operation.

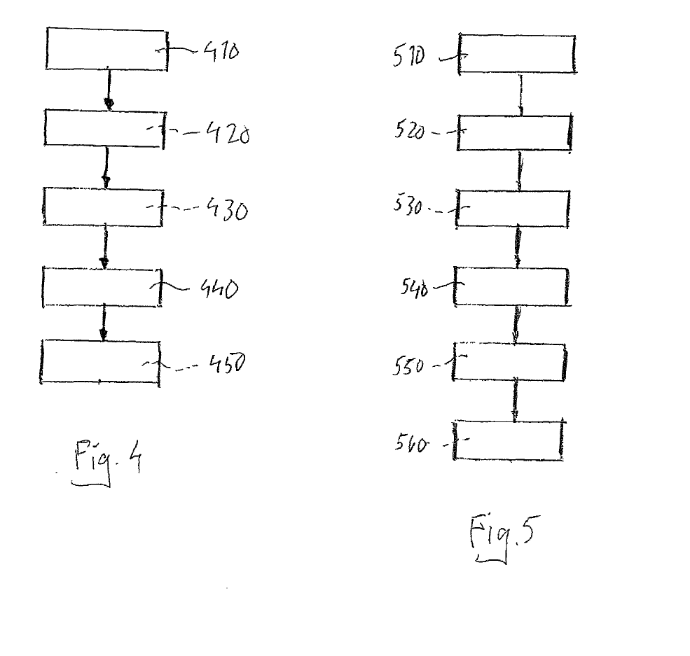

In FIG. 4 the steps of the method according to the present invention are illustrated.

Thus, in a first step 410 steel washers 1 are produced.

In a second step 420, which is a preferred but not always necessary step, the washers are cleaned to receive a clean surface suitable to be coated.

In a third step 430, which is also a preferred but not always necessary step, a layer 310 of pure nickel is electrolytically applied as a basic coating for said outer surface layer 7.

In a fourth step 440, a batch of washers 1 is provided with said surface layer 7. According to preferred embodiments said surface layer comprises a nickel/phosphorus alloy as described above. Also preferred is that an electroless nickel plating process is used for applying the surface layer 7, preferably performed as a barrel plating process.

In a fifth step 450, which is a preferred but not always necessary step, the surface layer 7 of said washers is heat treated at about 400° C. for about 1 hour or at 200-300° C. for up to about 12 hours, preferably in an inert atmosphere. Preferably the surface layer 7 is heat treated to about 1000 HV.

According to preferred embodiments the washers are made of stainless steel, especially preferred of acid-proof stainless steel.

According to one aspect of the present invention a plant is provided for producing washers for locking in bolted joints, the washers being of the kind discussed above, one embodiment of such a plant being shown in FIG. 5.

Thus, the plant comprises means 510 for producing steel washers e.g. substantially of the kind shown in FIG. 4. Preferably, the plant further comprises means 520 for cleaning washers produced and preferably means 530 for electrolytically applying a layer 310 of pure nickel on the washers as a basic coating. Further, the plant comprises means 540 for applying an outer surface layer 7 on a batch of washers, said surface layer 7 being a nickel alloy. According to preferred embodiments said layer 7 consists of a nickel/phosphorus alloy and for application of said layer an electroless nickel plating process is used, preferably a barrel plating process. Further, the plant preferably comprises means 550 for heat treatment of the washers and means 560 for controlled cooling of heat treated washers.

According to another aspect of the present invention the outer surface layer provided on a batch of steel washers is applied by means of a physical vapor deposition, PVD, process, said outer surface layer being made of at least one of the compounds titanium nitride, TiN, titanium carbonitride, TiCN, chromium nitride, CrN, and titanium aluminium nitride, TiAlN.

An outer surface layer of this kind provides both the desired hardness and the desired stainless properties for the washer pattern of teeth side of the batch of washers. The layer thickness is preferably about 0.5-50 μm.

According to this aspect of the present invention a method according to the present invention comprises the steps corresponding to the previously described steps 410, 420 and 430, the step 430 being the step comprising the PVD process.

Further, according to this aspect of the present invention, a plant according to the present invention comprises means corresponding substantially to the previously described means 510, 520 and 540, means 540 comprising means for providing the PVD process for providing the outer surface layer for a batch of washers.

The washer as well as the method and the function of the plant according to the present invention should to a considerable and necessary extent have been made clear by the description given above.

Thus, the present invention makes it possible to produce metallic washers having an outer surface layer, which provides a hardness for, inter alia, the pattern of teeth side of the washers, this hardness exceeding, if desired, the hardness of the material into which the teeth are intended to grip, such as a bolt head or a nut.

The nickel/phosphorus alloy layer has an amorphous or to a certain degree amorphous structure and provides the desired hardness as well excellent stainless and acid-proof properties.

Said alloy is also extremely suitable for batchwise application, e.g. in a barrel plating process, which provides a low cost production.

Said alloy may also be heat treated to a desired hardness.

Further, a nickel alloy according to the invention also provides excellent stainless properties according to, inter alia, the amorphous structure.

Embodiments specifying cleaning and embodiments specifying the provision of an electrolytically applied basic coating of pure nickel provides a good connection of the outer surface layer.

The present invention using PVD process provides a washer outer face having the desired hardness and also the desired corrosion resistance properties. Normally a cleaning operation should be performed as part of the PVD process aspect of the invention.

Above the present invention has been described in association with examples and preferred embodiments.

Of course, further embodiments as well as minor additions and changes may be imagined without departing from the basic inventive idea.

Thus, the present invention is also applicable for so-called friction locking washers.

Thus, the present invention should not be considered limited to the embodiments shown but may be varied within the scope of the accompanying claims.

1. A method for producing metallic washers for locking in bolted joints, the washers having an annular configuration and on one side a pattern of radially extending cams and on the other side having a pattern of radially extending teeth, comprising:
coating a batch of washers with a corrosion resistant outer surface layer, the hardness of which exceeding the hardness of the material to interact with the washer pattern of teeth in a locking operation.

2. A method according to claim 1, wherein said outer washer surface layer is a layer of a nickel alloy.

3. A method according to claim 1 wherein said outer washer surface layer is a nickel/phosphorus alloy.

4. A method according to claim 3, wherein said outer washer surface layer is a nickel/phosphorus alloy comprising about 2-14% phosphorus by weight.

5. A method according to claim 2, wherein said outer washer surface layer is applied by an electroless nickel plating process.

6. A method according to claim 2, further comprising the steps of
cleaning the washer surface in a cleaning operation; and then
applying electrolytically a layer of pure nickel before providing said outer washer surface layer of said nickel alloy.

7. A method according to claim 1, wherein the outer washer surface layer has a thickness of about 10-50 μm.

8. A method according to claim 4, further comprising the step of
heat treating said outer washer surface layer of said washers at about 400° C. for about 1 hour or at 200-300° C. for up to about 12 hours.

9. A method according to claim 8, wherein said outer washer surface layer is heat treated to a hardness of about 1000 HV.

10. A method according to claim 1, wherein the outer surface layer is made of at least one of the compounds titanium nitride, TiN, titanium carbonitride, TiCN, chromium nitride, CrN, or titanium aluminum nitride, TiAlN, and is applied by a physical vapor deposition process.

11. A method according to claim 10, wherein said outer surface layer has a thickness of about 0.5-50 μm.

12. A method according to claim 1, wherein the washers are washers of one of steel, stainless steel, or acid proof stainless steel.

13. A metallic washer for locking in bolted joints, the washer comprising a flat annular configuration with a central hole and on one side having a pattern of radially extending cams and on the other side having a pattern of radially extending teeth, wherein the washer is coated with a corrosion resistant outer surface layer, the hardness of which exceeding the hardness of the material to interact with the washer pattern of teeth in a locking operation.

14. A washer according to claim 13, wherein said outer washer surface layer is a layer of a nickel alloy.

15. A washer according to claim 13, wherein a basic coating layer of electrolytically applied pure nickel is provided under said surface layer of a nickel alloy.

16. A washer according to claim 13, wherein said surface layer comprises a nickel/phosphorus alloy.

17. A washer according to claim 16, wherein said nickel/phosphorus alloy comprises about 2-14% phosphorus by weight.

18. A washer according to claim 14, wherein said outer washer surface layer is applied by an electroless nickel plating process.

19. A washer according to claim 13, wherein said surface layer is about 10-50 μm thick.

20. A washer according to claim 14, wherein said surface layer is heat treated at about 400° C. for about 1 hour or at 200-300° C. for up to about hours, in an inert atmosphere and to a hardness of about 1000 HV.

21. A washer according to claim 13, wherein said metallic washers are made of one of steel, stainless steel, or an acid-proof stainless steel.

22. A washer according to claim 13, wherein said washer outer surface layer is applied by a physical vapor deposition, PVD, process, said layer being made of at least one of the compounds titanium nitride, TiN, titanium carbonitride, TiCN, chromium nitride, CrN, or titanium aluminum nitride, TiAlN.

23. A washer according to claim 22, wherein said outer surface layer is about 0.5-50 μm thick.

24. A plant for producing metallic washers for locking in bolted joints, the washers having a flat annular configuration with a central hole and on one side having a pattern of radially extending cams and on the other side having a pattern of radially extending teeth, comprising means for producing steel washers and means for batchwise coating of said steel washers with a corrosion resistant outer surface layer having a hardness exceeding the hardness of the material to interact with the washer pattern of teeth in a locking operation.

25. A plant according to claim 24, wherein said means for batchwise coating provides a surface layer comprising a nickel/phosphorus alloy comprising about 2-30% phosphorus.

26. A plant according to claim 24, wherein said means for batchwise coating apples the washer outer surface layer comprising at least one of the compounds of titanium nitride, TiN, titanium carbonitride, TiCN, chromium nitride, CrN, or titanium aluminum nitride, TiAlN by a physical vapor deposition, PVD, process.

27. A plant according to claim 24, wherein said washers are made of one of steel, stainless steel, or acid-proof stainless steel.
